(19) United States
(12) Patent Application Publication
(10) Pub. No.: US 2014/0351661 A1
(43) Pub. Date: Nov. 27, 2014

(54) OUTPUTTING FAULT DATA FOR A HARDWARE DEVICE

(71) Applicant: International Business Machines Corporation, Armonk, NY (US)

(72) Inventors: Alain Benayoun, Cagnes sur Mer (FR); Jean-Francois Fauh, Vence (FR); Claude Gomez, Antibes (FR); Patrick Michel, LaGaude (FR); Christian Ouazana, Vence (FR)

(73) Assignee: International Business Machines Corporation, Armonk, NY (US)

(21) Appl. No.: 14/264,460

(22) Filed: Apr. 29, 2014

(30) Foreign Application Priority Data
May 23, 2013 (GB) 1309265.5

(51) Int. Cl. G06F 11/07

(52) U.S. Cl. CPC G06F 11/0766
USPC 714/57

(57) ABSTRACT

A fault display module for a hardware device includes an external power input for providing power to the fault display unit when the associated hardware device is disconnected from its power supply.

### BACKGROUND

The present invention relates to outputting fault data for a hardware device.

Hardware systems utilizing one or more microprocessors commonly comprise fault monitoring systems arranged to monitor and report faults in the hardware system. Such fault monitoring systems commonly run tests and collect fault data indicative of any relevant faults identified. The fault data is commonly encoded and stored in a hardware register and displayed on a visual display such as an LED array associated with the relevant hardware. The hardware register is commonly fed by the normal power supply of the hardware system and an auxiliary power supply such as a lithium cell or a large capacitor sometimes referred to as a super-cap.

In order to read the fault data, the hardware system is powered down and a push button on the front panel of the hardware device is operated to power the hardware register from the auxiliary power supply so as to display the fault data on the visual display. The engineer is then able to identify and replace the faulty element of the hardware device.

### SUMMARY

An embodiment of the invention provides an apparatus for outputting fault data for a hardware device. The apparatus includes a first power input for receiving power from a first power supply for the hardware device. The apparatus includes an input for receiving fault data. The apparatus includes non-volatile data storage for storing the input fault data. The apparatus includes an output for outputting the fault data from the non-volatile storage to a display device. The apparatus includes a second power input for receiving power for the apparatus from a second power source external to the apparatus, the apparatus being operable to output the fault data from the non-volatile storage to the display device in response to power being input to the second power input.

Another embodiment provides a method for outputting fault data for a hardware device. The method includes powering an apparatus via a first power input from a first power supply for the hardware device. The method includes inputting fault data for the hardware device. The method includes storing the fault data in non-volatile data storage. The method includes outputting the fault data from the non-volatile storage to a display device in response to power input via a second power input of the apparatus from a second power supply external to the apparatus.

### BRIEF DESCRIPTION OF THE DRAWINGS

Embodiments of the invention will now be described, by way of example only, with reference to the following drawings in which:

FIG. 1 is a schematic representation of a computer system comprising a rack of rack-mounted computers;

FIG. 2 is a schematic representation of the internal architecture of one of the computers of FIG. 1 comprising a fault display module;

FIG. 3 is a flow chart illustrating processing performed by the fault display module of FIG. 2 when storing fault data from the computer; and

FIG. 4 is a flow chart illustrating processing performed by the fault display module of FIG. 2 in response to being powered up.

### DETAILED DESCRIPTION

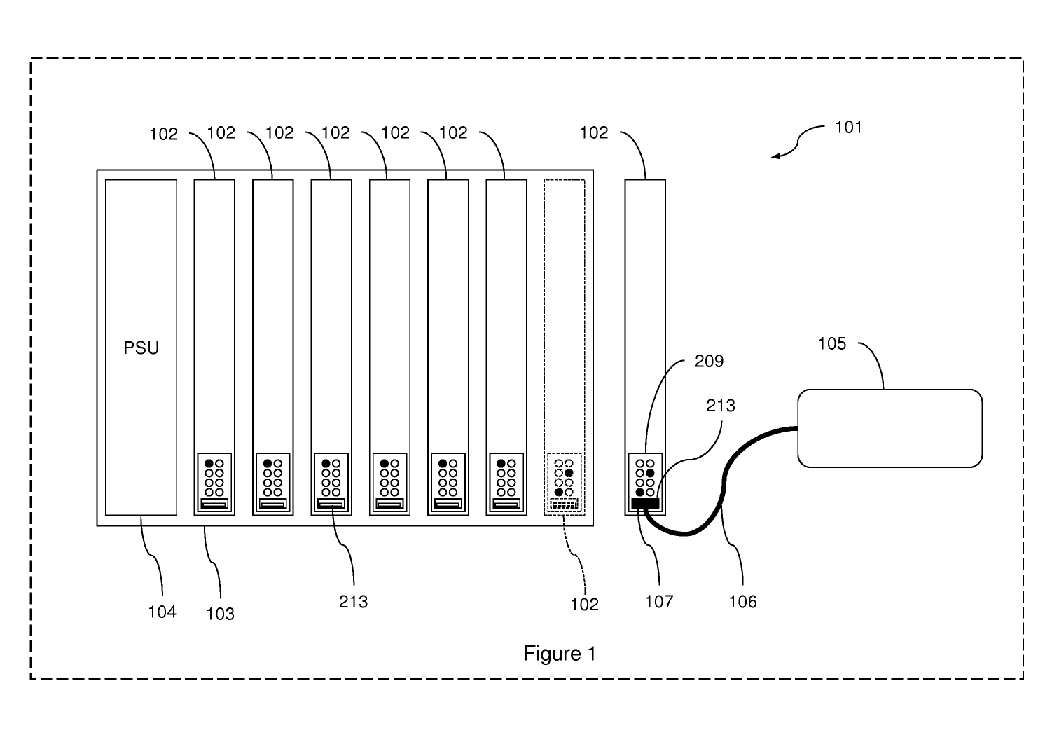

With reference to FIG. 1, a computer system 101 comprises a set of hardware devices in the form of a group of computers 102 in the form of blade computers installed in a rack 103 and connected to a network (not shown). In the present embodiment, each of the computers 102 is running server applications (not shown) providing services over the network. Thus, the computers 102 may also be referred to as blade servers. The rack comprises a power supply unit (PSU) 104 arranged to provide power to each of the computers 102 when installed in the rack 103.

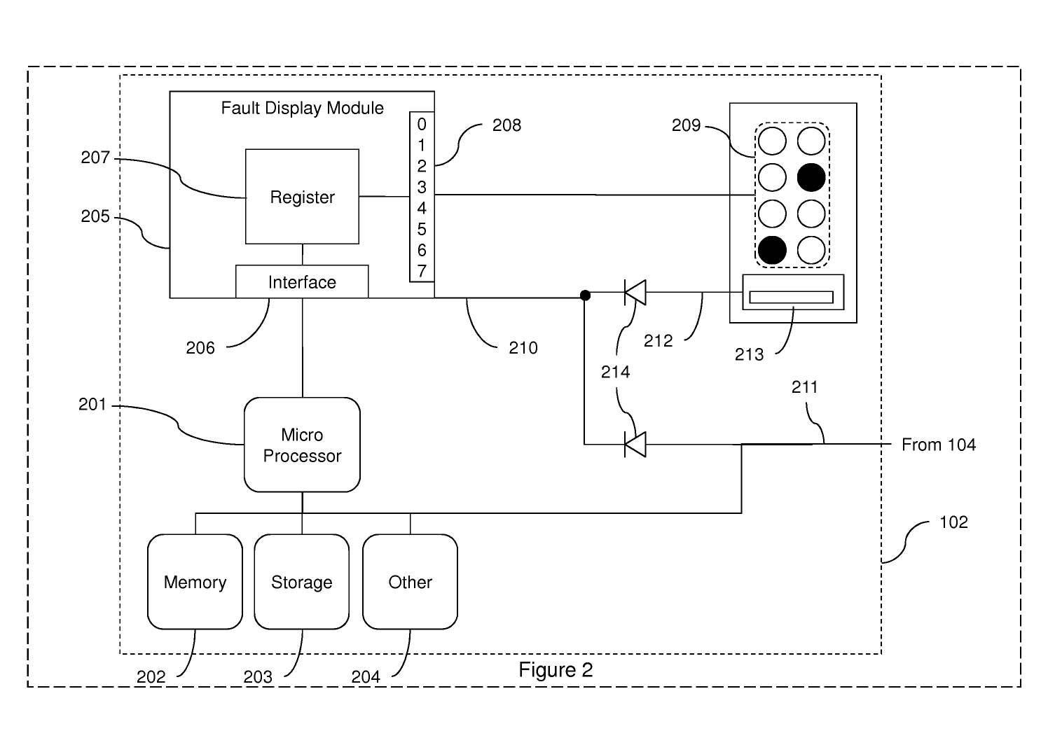

With reference to FIG. 2, each computer 102 comprises a microprocessor 201 connected to memory 202, storage 203 and other typical hardware facilities 204. The microprocessor 201 is typically arranged to run fault monitoring software or firmware arranged to identify and report faults with monitored elements of the computer 102. In response to the identification of a fault, the microprocessor 201 passes data representing the fault to a fault display module 205. In the present embodiment, the microprocessor 201 is arranged to encode the fault data as an 8-bit word.

The fault display module 205 comprises an input interface 206, a register 207 and an output register 208. The input interface 206 is arranged for inputting the fault data from the microprocessor 201. The register 207 is implemented in non-volatile memory for storing the input fault data. The output interface 208 is arranged for outputting the data stored in the register 207. The fault display module 205 is thus arranged to receive input fault data from the microprocessor 201 via the input interface 206. The fault display module 205 then reads the input fault data from the input interface 206 and stores it in the non-volatile register 207. The fault display module 205 is further arranged to automatically output the fault data stored in the register 207 via the output register 208. The fault display module 205 is arranged so that each time new fault data is received from the microprocessor 201, the data in the register 207 is overwritten and correspondingly output on the output interface 208.

In the present embodiment, a suitably programmed Complex Programmable Logic Device (CPLD) that comprises part of the computer 102 provides the fault display module 205. The CPLD is programmed so as to provide a hardware state machine arranged to provide the processing of the fault display module 205 as described herein. In the present embodiment, the input interface 206 is implemented using the Inter Integrated Circuit (I2C) bus protocol for communication with the microprocessor 201 and the output interface 208 is implemented using the General Purpose Input/Output (GPIO) interface of the CPLD. In the present embodiment, the non-volatile register 207 is implemented in an Electronically Erasable Programmable Read Only Memory (EEPROM) within the CPLD.

The output interface 208 of the fault display module 205 is connected to a display 209 in the form of a light array for displaying the fault data stored in the register 207. In the present embodiment, the light array 209 comprises 8 light emitting diodes (LEDs). The 8-bit fault data output from the microprocessor 201 in the form of a fault data byte is written to the register 207 and then output via the output interface 208 to the light array 209. Each of the 8 bits of the fault data byte corresponds to a predetermined one of the 8 LEDs of the light array 209.

The components of the computer 102 are powered in use by power supplied and routed from the PSU 104 in the rack 103. The fault display module 205 comprises a power supply 210 having a first branch 211 that inputs power from the PSU 104. In the present embodiment, the power input of the fault display module 205 comprises a second branch 212 connected to a power input 213 in the form of a connector. In the present embodiment, the power input 213 comprises a female Universal Serial Bus (USB) connector. Each branch 211, 212 comprises a respective diode 214 arranged to ensure that power from the PSU 104 is not provided to the power input 213 and that power input via the USB power input 213 is only supplied to the fault display module 205. The second branch 212 is arranged such that power supplied via the USB power input 213 is provided to the fault display module 205 in isolation from the remaining parts of the computer 102.

With reference to FIG. 1, in the present embodiment, the light array 209 is located on the front of the respective computer 102 so as to be visible when the computer 102 is installed and operating in the rack 103. In FIG. 1, the rightmost computer 102 is indicating a fault via the light array 209. The faulty computer 102 is therefore powered down and removed from its location in the rack 103 (shown in dotted lines) to a position outside the rack 103 as shown in FIG. 1. Removing the computer 102 from the rack disconnects the computer 102 from the power supply of the PSU 104. A portable power source 105 is provided in the form of a laptop computer having a connected cable 106 terminating in a connector 107 in the form of a male USB connector. The portable power source 106 is arranged to provide power via the cable 106 and connector 107. Plugging the connector 107 into the power input 213 as shown in FIG. 1 provides power from the portable power source 106 to the fault display module 205 via the second branch 212 of the power supply 210. In the present embodiment, the power from the portable power source 106 is provided to the fault display module 205 in isolation from the remaining elements of the computer 102. Powering up the fault display module 205 results in the fault data stored in the non-volatile register 207 being output and displayed via the light array 209. The fault data is thus provided for the computer 102 when disconnected from the PSU 104 and enables diagnosis of the fault by a technician.

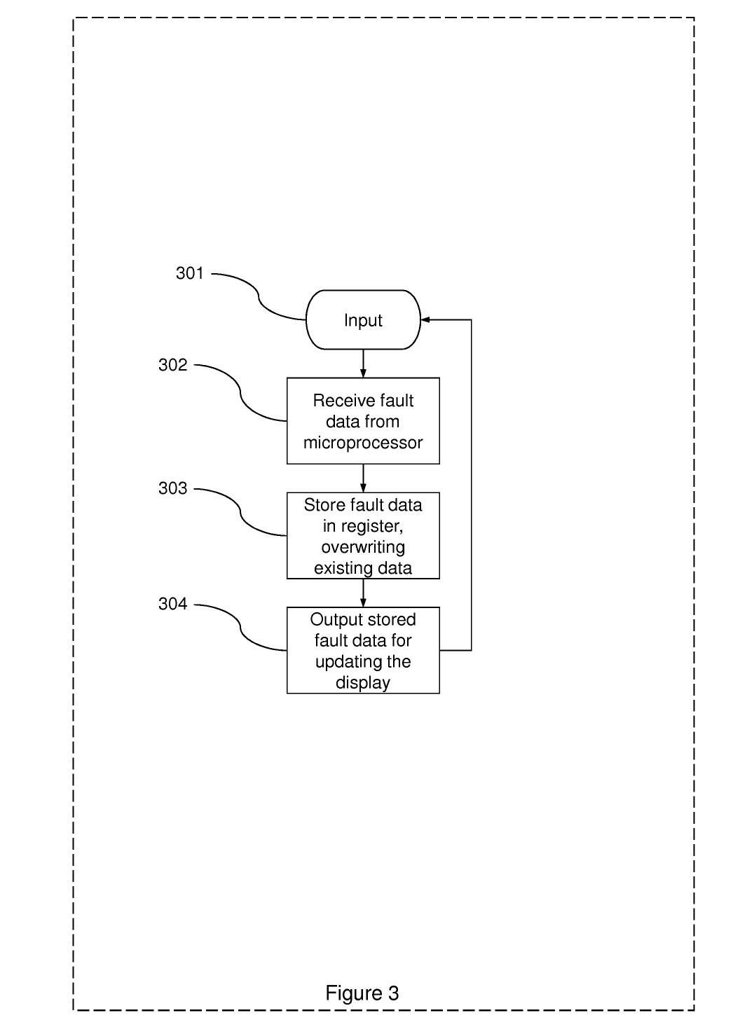

The processing performed by the fault display module 205 will now be described with reference to the flow chart of FIG. 3. Processing is initiated at step 301 in response to an input being received from the microprocessor 201 on the input interface 206 and processing moves to step 302. At step 302 the input fault data is read from the input interface 206 and processing moves to step 303. At step 303 the fault data is written to the register 207 overwriting any existing data in the register 207 and processing moves to step 304. At step 304 the fault data stored in the register 207 is output via the output interface 208 so as to display the fault data on the light display 209 of the computer 102. Processing then returns to step 301 to await further input as described above.

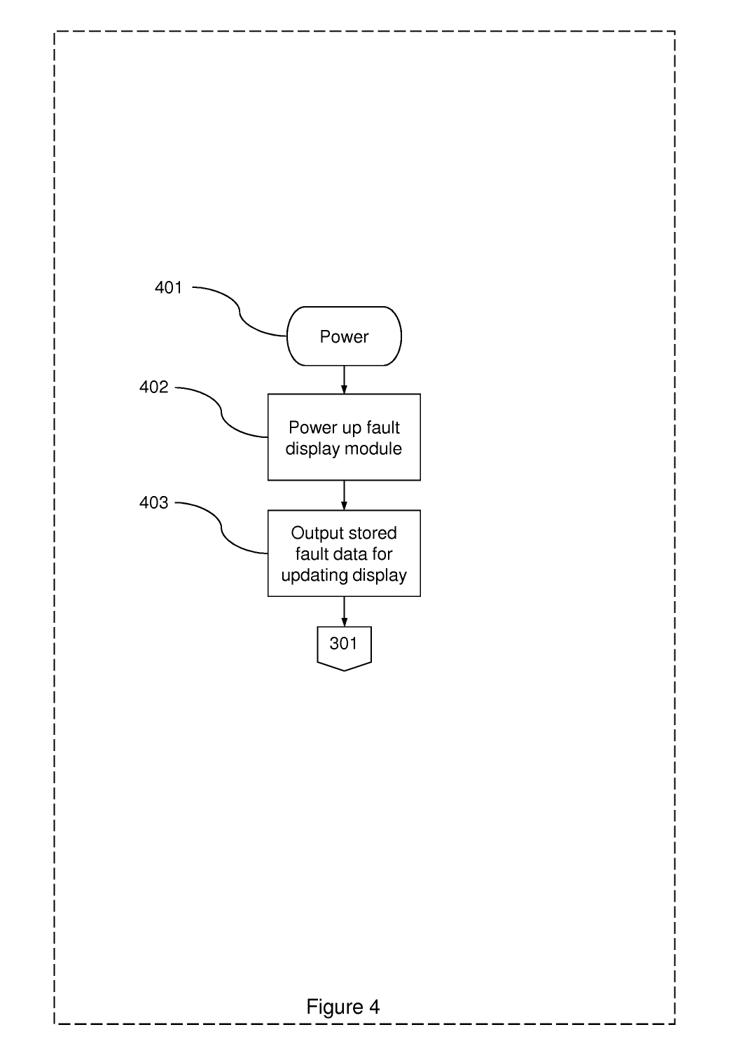

The processing performed by the fault display unit 205 in response to receiving power, for example, from the portable power source 106 connected to the power input 213 in isolation from the other parts of the computer 102, will now be described with reference to FIG. 4. Processing is initiated at step 401 by the supply of power to the fault display unit 205 via the power supply 210 from either the PSU 104 or the portable power source 106 and processing moves to step 402. At step 402 the fault display unit is powered up and processing moves to step 403. At step 403 the fault data currently stored in the register 207 is output via the output interface 208 for updating the display 209 with the current fault data. Processing then moves to step 301 of FIG. 3 to await further fault data input as described above.

Embodiments of the invention remove the need for an on-board auxiliary power supply and may thus reduce the part count for the relevant apparatus. For example, the use of power sources such as lithium ion cells or super-caps may be reduced.

The second power input may be arranged to supply external power to the apparatus in isolation from the hardware device. The second power input may be arranged to supply power to the apparatus in isolation, for outputting the fault data to the display device only. The apparatus may be operable to output the fault data to the display device in response to power input to the first or second power inputs.

The second power input may be provided via an external connector of the apparatus. The second power input may be provided via a Universal Serial Bus (USB) connector of the apparatus. The display device may comprise an array of lights operable to represent the fault data. The fault data may be input from a fault detection function for the hardware device. The hardware device may comprise one or more microprocessors.

The input to the apparatus from the hardware device comprises an Inter Integrated Circuit (I²C) input interface. The hardware device and apparatus may be unitary. The apparatus may be provided as a module of the hardware device. The hardware device may comprise a computer. The hardware device may comprise a blade computer.

As will be understood by those skilled in the art, the fault display module may be implemented in any suitable manner for a given embodiment. For example, the fault display functionality may be integrated with one or more elements of the hardware device with which it is associated. The fault display functionality may be provided by specialised hardware, firmware or software. The firmware or software may be arranged to run on a general purpose or at leas partly specialised hardware device.

As will be understood by those skilled in the art, the display for display the fault data may be located at any suitable point on or in association with the relevant hardware device or computer. The display may be any suitable display such as a liquid crystal display (LCD) or electromechanical display or audio output device.

As will be understood by those skilled in the art, the connector 213 may by any suitable connector type or standard for providing an external electrical connection. Furthermore, the connector may be located at any suitable point on the hardware device or computer and need not be located adjacent the display. The external power source may be any suitable power source such as a dedicated fault display module power unit such as a battery pack that may be rechargeable.

It will be understood by those skilled in the art that the apparatus that embodies a part or all of the present invention may be a general purpose device having software arranged to provide a part or all of an embodiment of the invention. The device could be a single device or a group of devices and the software could be a single program or a set of programs. Furthermore, any or all of the software used to implement the invention can be communicated via any suitable transmission or storage means so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details of the representative apparatus and method, and illustrative examples shown and described. Accordingly, departures may be made from such details without departure from the scope of applicant's general inventive concept.

What is claimed is:

1. An apparatus for outputting fault data for a hardware device, comprising:
a first power input for receiving power from a first power supply for the hardware device;
an input for receiving fault data;
non-volatile data storage for storing the input fault data;
an output for outputting the fault data from the non-volatile storage to a display device; and
a second power input for receiving power for the apparatus from a second power source external to the apparatus, the apparatus being operable to output the fault data from the non-volatile storage to the display device in response to power being input to the second power input.

2. The apparatus according to claim 1, wherein the second power input is arranged to supply external power to the apparatus in isolation from the hardware device.

3. The apparatus according to claim 1, wherein the second power input is arranged to supply power to the apparatus in isolation, for outputting the fault data to the display device only.

4. The apparatus according to claim 1 operable to output the fault data to the display device in response to power input to the first or second power inputs.

5. The apparatus according to claim 1, wherein the second power input is provided via an external connector of the apparatus.

6. The apparatus according to claim 1, wherein the second power input is provided via a Universal Serial Bus (USB) connector of the apparatus.

7. The apparatus according to claim 1, wherein the display device comprises an array of lights operable to represent the fault data.

8. The apparatus according to claim 1, wherein the fault data is input from a fault detection function for the hardware device.

9. The apparatus according to claim 1, wherein the hardware device comprises one or more microprocessors.

10. The apparatus according to claim 1, wherein the input to the apparatus from the hardware device comprises an Inter Integrated Circuit (I²C) input interface.

11. The apparatus according to claim 1, wherein the hardware device and apparatus are unitary.

12. The apparatus according to claim 1, wherein the apparatus is provided as a module of the hardware device.

13. The apparatus according to claim 1, wherein the hardware device comprises a computer.

14. The apparatus according to claim 1, wherein the hardware device comprises a blade computer.

15. A method for outputting fault data for a hardware device, comprising:
powering an apparatus via a first power input from a first power supply for the hardware device;
inputting fault data for the hardware device;
storing the fault data in non-volatile data storage; and
outputting the fault data from the non-volatile storage to a display device in response to power input via a second power input of the apparatus from a second power supply external to the apparatus.

16. The method according to claim 15, wherein the second power input is arranged to supply external power to the apparatus in isolation from the hardware device.

17. The method according to claim 15, wherein the second power input is arranged to supply power to the apparatus in isolation, for outputting the fault data to the display device only.

18. The method according to claim 15, wherein the fault data is output to the display device in response to power input to the first or second power inputs.

19. The method according to claim 15, wherein the second power input is provided via an external connector of the apparatus.

20. The method according to claim 15, wherein the second power input is provided via a Universal Serial Bus (USB) connector of the apparatus.
